(19) United States
(12) Patent Application Publication
(10) Pub. No.: US 2017/0279807 A1
(43) Pub. Date: Sep. 28, 2017

(54) SAFE METHOD TO SHARE DATA AND CONTROL THE ACCESS TO THESE IN THE CLOUD

(71) Applicant: Juan José Bermúdez, Sant Just Desvern (ES)

(72) Inventor: Juan José Bermúdez, Sant Just Desvern (ES)

(21) Appl. No.: 15/465,852

(22) Filed: Mar. 22, 2017

(30) Foreign Application Priority Data
Mar. 23, 2016 (ES) P201630357

(51) Int. Cl. H04L 29/06; H04L 9/32

(52) U.S. Cl. CPC H04L 63/10; H04L 63/0823; H04L 63/0435; H04L 63/061; H04L 63/123; H04L 9/3247

(57) ABSTRACT

The object of the present invention is to create a method for storing data in the cloud that ensures the privacy of the said data even against the administrators of the servers that make up the cloud, without impeding the practical and convenient management of the access permissions to such data. This guarantee is obtained by encrypting the stored data and the distributed and partitioned storage (for example, by the Shamir method) of the keys that allow decrypting the said data. When this method is implemented, an attacker, who wants to access the data in an unauthorized manner, should obtain unauthorized access to at least two different servers, located in different physical locations and administered by different authorities.

### BACKGROUND

Data storage in the Cloud¹ is a widely-extended service today. Individuals and businesses see in this option a way to lower costs and improve flexibility, as they do not have to worry about establishing an IT infrastructure, and can access data from any device anywhere with an Internet connection. In addition, especially for professional and business purposes, it is useful to be able to share files with other users, so offering a system of permissions to manage access to them is very useful (WO 2015069234 A1).

More recently, safety and cost reduction requirements have been added. News about threat of computer espionage to big companies, and even governments, have sensitized the market in this sense. To meet these new concerns, different services offer the possibility of encrypting information stored in the cloud (U.S. Pat. No. 9,027,108 B2). Generally, the said encryption is done by means of a symmetric key that only knows the user who transmits the file to be stored in the cloud. If the user wants another user to have access to that file, he has to transmit the password to him. Apart from the obvious practical drawbacks of this system, there is the problem of non-revocability of the permissions; once a key has been sent, the user always has access to the file. Likewise, if the owner of the file modifies the key, it should transmit the new key to all the users to whom he/she/they wanted to maintain the permission.

Another disadvantage of this security option is that the key is stored in a single location, and if someone had illegitimate access to the computer system that holds the key or keys, they would have access to all the files.

Storing files in the cloud is actually a problem common to many other Internet services that offer storing of data in the cloud, and providing access permissions to that data. They are, for example, equivalent services, such as instant messaging, and posting messages on social networks or discussion forums. In all these cases, there is a user who uploads an information and grants permissions on it. Recently, there has also been an increased concern of the users of this type of services about the security and privacy.

The requirement of security and privacy is often especially important for corporations and organized associated entities.

### Definitions:

1. The Cloud. Cloud Computing, also known as Cloud Services, is a paradigm that allows one to offer computer services over a network, which usually Is the Internet.

### BRIEF DESCRIPTION OF THE INVENTION

The present invention relates to a system for protecting and controlling access to data stored in an independent remote computing infrastructure (commonly referred to as the “cloud”).

The system consists of a Terminal, which, in the context of the present invention, and under the general concept of a computer terminal, is any device capable of displaying the contents of a web page or digital content, including computers, mobiles, handheld computers, laptops, smart watches, smart glasses, digital televisions, etc.

(a) A Local Agent (downloadable or pre-installed on the terminal) that incorporates (and performs) the necessary operations to interact with the servers in the cloud and locally manage the data. This module includes (non-exclusive) software for communication, encryption, information certification, and error detection. In case the user of the tool is an electronic circuit or computer, the Local Control Agent may be integrated in the same circuit, be part of the computer software, or a separate device connected to the circuit or computer.

There will be (b) one (or more) Data Control Server(s), which (among other functions) collect(s) the information provided by the terminals, monitors compliance with data control policies, stores access key shares and implements policies to minimize the risks of data loss.

There will be (c) one (or more) Access Verification Server(s) that will monitor the access policies implemented by the Data Control Server and will save one or more shares of the data access keys.

Optionally, there may be (d) one (or more) separate network(s) of interconnected Storage Servers, offering a virtual cloud storage system.

The characteristics of the invention make the keys to access any set of data not being stored in a single point/location or under the supervision of a single authority. The key to decrypt the stored data is split into several shares by a secret sharing algorithm. Some of these shares are stored in the Data Control Server, some others in the Access Verification Server, and the remaining by the user who enters the data into the system. To recompose the key and decrypt the data will require a certain minimum number of shares. In this way, even if there is a theft of some of the shares with one of the authorities, such shares will be useless without access to the minimum number of shares necessary to decrypt the data, which will be guarded by different authorities. The access permissions to the data, therefore, will be guarded in a cryptographically safe way by several authorities (ideally independent).

### BRIEF DESCRIPTION OF THE DRAWINGS

FIG. 1a shows a possible data stream produced during steps iii and iv of the method for storing data in the detailed description of the present invention.

FIG. 1b shows a possible data stream produced between steps viii and xiii of the method for storing data in the detailed description of the present invention.

FIG. 1c shows a possible data flow produced between steps ii and vii of the method for downloading data in the detailed description of the present invention.

FIG. 1d shows a possible data stream produced in step ix of the method for downloading data in the detailed description of the present invention.

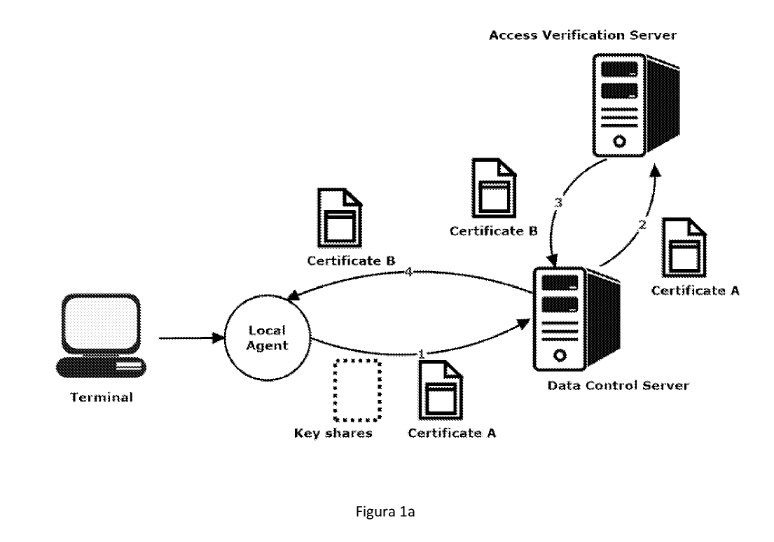

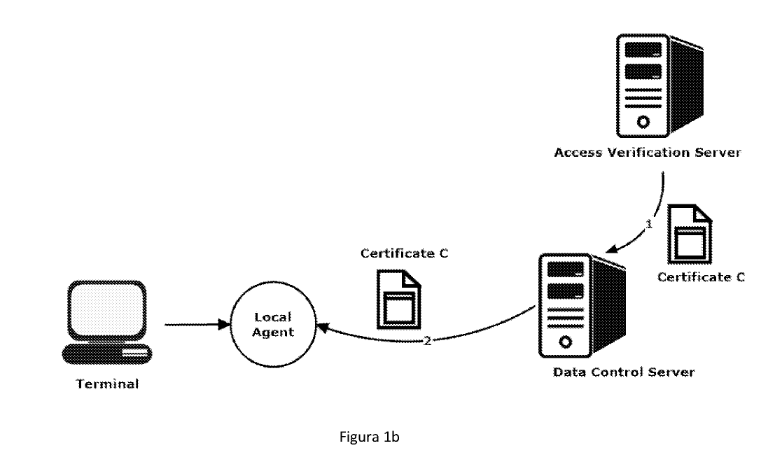

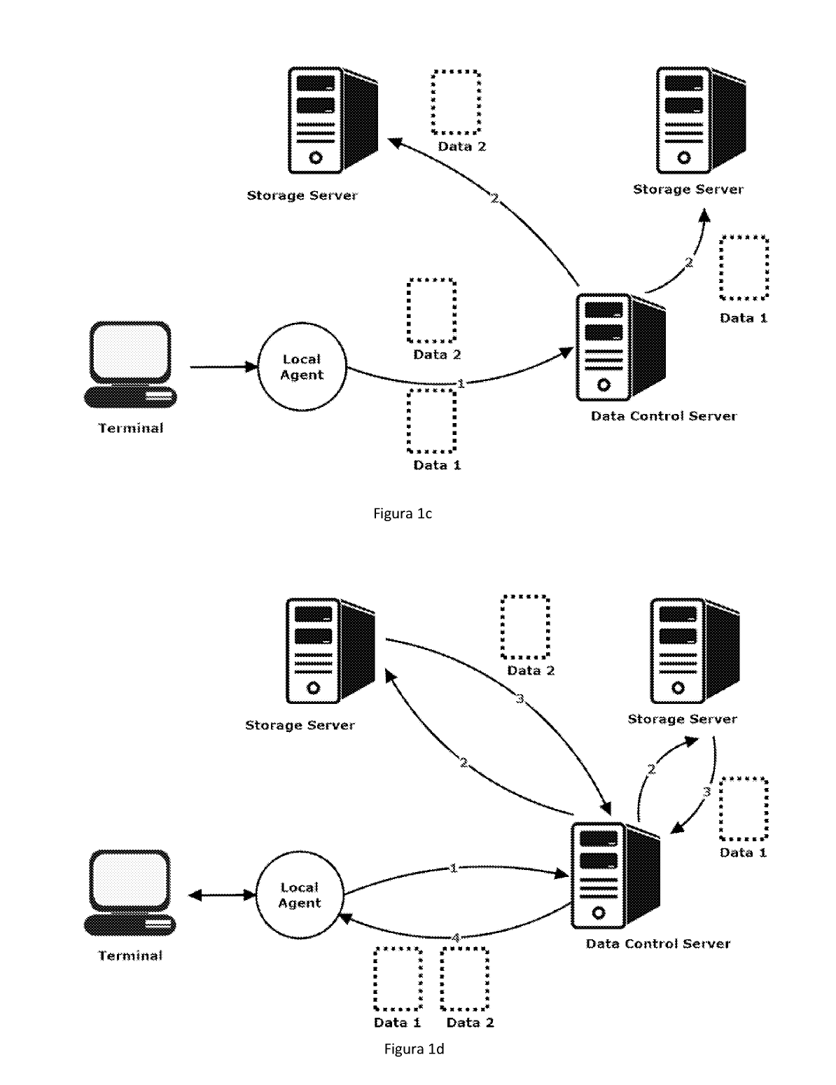

### DETAILED EXPLANATION OF THE INVENTION

TLS. Transport Layer Security (TLS) and its predecessor, Secure Sockets Layer (SSL) are cryptographic protocols that provide secure communications over a network, commonly the Internet.

Digital Certificate. A digital certificate or electronic certificate is a computer file generated by a certification service entity that associates identity data with a natural person, body, or company, thus confirming its digital identity on the Internet. The digital certificate is valid mainly to authenticate a user or website on the internet, so it is necessary to secure the collaboration of a trustworthy third party involved in the communication. The name associated with this trusted entity is the Certifying Authority and can be a public body or recognized company on the Internet.

Token. Random character string that a software agent obtains once it has been authenticated with a server and which allows it to maintain credentials with that server without having to authenticate in each operation. Usually the token has a validity limited in time.

### Previous Assumptions:

Each Local Agent has a pair of asymmetric keys (a public key and a private key).
Each Access Verification Server has a pair of asymmetric keys (one public and one private).
Optionally, the Data Control Server can have a pair of asymmetric keys.
The public keys of any pair of asymmetric keys are known by all elements involved in this invention, whereas private keys are only known by their owners (unless otherwise indicated).
There is a protocol, not specified in this invention, for assigning different permissions to different data groups. For example, the Local Agent could use HTTP to communicate to/with both the Data Control Server and the Access Verification Servers the permissions of each data unit, each user, different groups of users, and the groups to which each user belongs.

### Procedure for Storing Data in the Cloud

The following steps need not necessarily be carried out in the order described below:

(i) The Local Agent generates a random key. This key will usually correspond to the key for a symmetric encryption algorithm. Usually it will be a key for the AES or Triple DES algorithm, although it can be any key 100 that can be used in any algorithm with similar characteristics.

(ii) The Local Agent encrypts with the previous key the data that the user of the Terminal wants to send to the cloud. Such data may be, for example, without exclusion:
A computer file
A message within an instant conversation
A publication on a social network
A message in a forum

Optionally, instead of directly encrypting the data, the Local Agent can split the data by means of any secret-sharing algorithm (e.g. Shamir), so that each share is stored on a different server. For example, you could generate a share intended to be stored on the Access Verification Server (s). These shares would also be encrypted by the aforementioned key.

(iii) The Local Agent sends the encrypted data to the Data Control Server. Said transmission can be performed by any means; the method is not part of this invention. For example, the HTTP protocol can be used.

The Data Control Server will store all or part of that data in its own storage resources or transfer it to other Storage Servers to perform that function.

Optionally, the Data Control Server may send part of such data, or shares of that data, to one or more Access Verification Servers for storage.

Optionally, the Local Agent may directly send part of the said data, or shares of it, to one or more Access Verification Servers for storage.

Optionally, the Local Agent may directly send part of such data, or shares of it, to one or more Storage Servers for storage.

(iv) The Data Control Server confirms receipt to the Local Agent. The protocol used to give such confirmation or the format of the said confirmation is not part of this invention.

Typically, it will be the response to an HTTP protocol GET or POST command. Also, typically, the TLS protocol will be used so that the Local Agent is certain that the data is being directed to the Data Control

Server, which will use a digital domain certificate.

(v) The Local Agent generates a certain number of key shares by means of a secret-sharing algorithm (for example, Shamir); a certain number of such shares are required (to be determined in each case) to recompose the key. A typical case would be the one in which three shares of the key are generated but only two shares are necessary to recompose the key.

(vi) The Local Agent encrypts through a public key belonging to the Access Verification Server a certain number of shares of the key with which the data was encrypted (Shares for the Access Verification Server). In case of more than one Access Verification Server, the operation will be repeated, making it possible to select different shares for each server and using the public key of each server. Typically, there will be only one Access Verification Server, for which one of the three shares generated will be selected.

(vii) The Local Agent signs a certificate using a digital signature algorithm (Certificate A) that identifies or contains the data sent to the Data Control Server and the encryption of the shares for the Access Verification Server. For example, the certificate could contain a fingerprint of the data, the identifier of the requested operation (in this case, save a file), and the encryption of the corresponding share.

If there is more than one Access Verification Server and there are different key shares for each one, a certificate will be generated and signed for each server.

Alternatively, instead of signing, the Local Agent could use any other method available in the state of the art to identify itself; for example, include in Certificate A a temporary token that it would have previously acquired from the Access Verification Server and would fulfill the same function of guaranteeing the identity of the user. In this case, the token would be a secret identifier obtained by a secure channel and that for a given time would allow the Local Agent to identify itself through the credentials that were previously sent through the said secure channel. The specific method to be used for identification is not part of this invention.

Optionally, the Local Agent could encrypt with a public key of the Data Control Server the shares sent to that server to be stored by it. Also, in that case, the Local Agent could generate another Certificate A, destined in this case to the Data Control Server, which would include the said digitally signed shares.

(viii) The Local Agent sends to the Data Control Server a Certificate and a certain number of shares of the key with which the data was encrypted (Shares for the Data Control Server). In a typical case, the HTTP protocol will be used for this transmission, making use of the TLS protocol to guarantee the privacy of the message and verify the identity of the parties. Typically, it will be sent Certificate A, the session ID, and information indicating the destination of the data. For example, if it is a computer file, it will include (among other possible options) the destination directory and the file name.

Optionally, the Local Agent can generate a Certificate A also for the Data Control Server, which will include the data to be received by it, and which will be encrypted with the public key of that server and digitally signed by the agent. Said certificate may replace, or not, the aforementioned data, sent by any other safe method.

As indicated, the order of the steps of this invention need not necessarily be that indicated. For example, steps v, vi, vii and viii could be performed perfectly before steps ii, iii and iv or even in parallel.

(ix) The Data Control Server verifies that the user has permissions to perform the operation and saves in a record the shares for the Data Control Server, associating them with the data in question. For example, if it is a request to post a message to a forum, it will verify that you have the permission to post to that forum, or if it is a request to save a file to a directory, it will verify that you have the write permission on that directory.

(x) The Data Control Server sends to the Access Verification Server the Certificate A that includes the encrypted shares for the Access Verification Server. If there is more than one Access Verification Server, the corresponding certificate will be sent to each server. The protocol of communication between servers does not form part of this invention, although it will typically be the HTTP protocol together with TLS to guarantee a secure channel.

In some possible implementation of this invention, the Local Agent would directly send the Certificate A to the Access Verification Server (s).

(xi) The Access Verification Server verifies that the certificate signature is correct, and that the signing user has permissions to perform the operation. Alternatively, if, for example, the user has not signed but has sent a temporary token, the server will check that the token was assigned to that user.

If everything is correct, it decrypts the key shares and saves them with a link to the certificate data.

(xii) The Access Verification Server optionally generates a certificate (Certificate B) containing information that identifies the request made by the user (included in Certificate A), encrypts that certificate with the public key of the user signing Certificate A, and signs the Certificate B with his own private key. For example, if the request consists of storing a file in a directory, the certificate could contain the file identifier, the directory identifier, the user id, a fingerprint of the shares and the date (none of these elements are indispensable). The purpose of the said Certificate B is to confirm to the Local Agent that the operation requested has been carried out.

Optionally, this certificate can be sent to the Local Agent that sent the request or can be saved in a database for later consultation.

Optionally, it can also be sent to the Local Agent that sent the request for a confirmation of the request by any other means, without the need to generate a certificate, for example, through a secure TLS channel over HTTP protocol.

(xiii) The Access Verification Server sends the encrypted and signed Certificate B to the Data Control Server or optionally a simple confirmation.

Optionally, the Access Verification Server may have sent the confirmation in the previous step directly to the Local Agent by any other means.

(xiv) The Data Control Server sends to the Local Agent a confirmation that the operation has been processed, and optionally the Certificate B obtained from the Access Verification Server.

(xv) The Local Agent:
a) Checks that the Data Control Server reports that the operation has been performed correctly, and optionally;
b) Verifies that the signature of Certificate B corresponds to the Access Verification Server, decrypts the certificate with its private key, and checks that Certificate B indicates that the Access Verification Server approves the operation and confirms it. This way, the Local Agent is certain that the Access Verification Server has received the shares of the key and that they are effectively on that server. Optionally, the Local Agent could have obtained this verification by any other method, for example, via a secure TLS channel with the Access Verification Server.
   Procedure for Downloading Data from the Cloud

(I) The Local Agent optionally generates a certificate (Certificate C) with the access request data, encrypts the certificate with the public key of the Access Verification Server, and signs it with its private key. If, for example, the user wants to read a message from the wall of a social network, the certificate will include the message identifier.

Optionally, the Local Agent can also generate a Certificate C for the Data Control Server, encrypted with the public key of this.

(ii) The Local Agent sends to the Data Control Server the access request data contained in Certificate C, as well as the said encrypted and signed certificate.

Optionally, the Local Agent can send the Certificate C directly to the Access Verification Server through any secure channel.

(iii) The Data Control Server verifies that the operation complies with the access protocols and, if so, sends the C Certificate as received from the Local Agent to the Access Verification Server. If, for example, the user is requiring read access to a publication on the wall of a social network, the Data Control Server will check that the user has permission to view the publication.

Optionally, Certificate C could have been sent to the Access Verification Server by any other means.

Optionally, the data contained in Certificate C could have been sent to the Access Verification Server by any other means that guarantees the security and privacy of the information. For example, through an HTTP connection and a secure channel through TLS.

(iv) The Access Verification Server decrypts the C Certificate (if it has been encrypted) with its private key, checks the signature and verifies that the signer has the necessary permissions to execute the operation specified in the said certificate following a Procedure similar to the Data Control Server.

(v) If the certificate data is correct and the user has the necessary permissions, he obtains the necessary key shares to decrypt the data, includes such shares in a new certificate (Certificate D), encrypts it with the Local Agent public key, and signs it with his own private key.

Optionally, the data of Certificate D can be sent to the Local Agent through any other type of secure channel. For example, if the Local Agent is connected via HTTP and TLS directly to the Access Verification Server, it can use the same channel to safely and privately return data from the Certificate D.

(vi) The Access Verification Server, optionally, sends to the Data Control Server the Certificate D.

(vii) The Data Control Server returns to the Local Agent the shares that it has stored to access the requested data, as well as, optionally, the Certificate D. If, for example, at the moment of breaking the key, it was done in three shares, requiring two shares to recompose the key, the Data Control Server will provide a share and the Access Verification Server sends another encrypted share to the D certificate (or through another secure channel) so that only the Local Agent can read it. These two shares may be sufficient to decrypt the data, but in case of loss of data from a server, the Local Agent of the user who uploaded the data to the cloud may have stored a third share by any other means, and that share together with that of one of the two servers, would allow the recovery of the data.

(viii) The Local Agent decrypts the D certificate (if it has been encrypted) with its private key and checks the signature of the Access Verification Server.

(ix) If both the Data Control Server and the Access Verification Server have given approval to the operation and have provided the necessary shares to recompose the key and decrypt the data, the Local Agent downloads the requested data from the address indicated by the Data Control Server. Such download may be against the same Data Control Server, against any Storage Server, or against the Access Verification Server. The method of internally storing the data in the cloud is not part of this invention; any method available in the state of the art can be employed. For example, you can use the cloud storage service of a third party (another company) without knowing what internal architecture they use.

Optionally, the stored data may have been divided into shares by any method of sharing secrets, and therefore the Local Agent must recompose the said data once downloaded.

(x) The Local Agent recomposes the key with which the data was encrypted from the key shares sent by the Data Control Server and the Access Verification Server (s). As stated above, the order of these steps need not be the one discussed here. For example, recomposition of the key can be done at any time since the key shares are accessed. It could be recomposed before downloading the data or in parallel.

(xi) The Local Agent decrypts the data with the obtained key. If, for example, the data corresponds to a message in an instant conversation, the Local Agent can display the message to the user on-screen or by any other means.

1. A method for securely sharing electronic data in the cloud by using at least one Terminal, one (or more) Local Agent(s), one Data Control Server, one (or more) Access Verification Terminal(s), and one or more Data Storage Server(s), comprise the said method:
(i) The Local Agent generates a random key.
(ii) The Local Agent encrypts with the previous key the data that the user of the Terminal wants to send to the cloud.
(iii) The Local Agent sends the encrypted data to the Data Control Server.
(iv) The Data Control Server confirms receipt to the Local Agent.
(v) The Local Agent generates a certain number of key shares by means of a secret-sharing algorithm (for example, Shamir), a certain number of such shares being necessary to recompose the key.
(vi) The Local Agent encrypts by means of a public key belonging to the Access Verification Server a certain number of shares of the key with which the data was encrypted (Shares for the Verification Server). In case of more than one Access Verification Server, the operation will be repeated, selecting different shares for each server and using the public key of each server.
(vii) The Local Agent signs a certificate using a digital signature algorithm (Certificate A) that identifies or contains the data sent to the Data Control Server and the encryption of the Shares for the Access Verification Server. If there is more than one Access Verification Server and different shares have been selected for each one, a certificate will be generated for each server. Alternatively, instead of signing, the Local Agent could send a temporary token that it would have previously acquired from the Access Verification Server and which would fulfill the same function of guaranteeing the identity of the user.
(viii) The Local Agent sends Certificate A to the Data Control server and a certain number of shares of the key with which the data was encrypted (Shares for the Data Control Server).
(ix) The Data Control Server verifies that the user has permissions to perform the operation and saves in a record the Shares for the Data Control Server, associating them with the data in question.
(x) The Data Control Server sends Certificate A to the Access Verification Server and the Shares for the Access Verification Server. In case there is more than one Access Verification Server, the corresponding Certificate and corresponding shares will be sent to each server.
(xi) The Access Verification Server verifies that the certificate signature is correct and that the signing user has permissions to perform the operation. Alternatively, if the user has not signed but sends a temporary token, the server will check that the token is assigned to that user. If everything is correct, it decrypts the shares and saves them with a link to the certificate data.
(xii) The Access Verification Server optionally generates a certificate (Certificate B) containing information that identifies the request made by the user (included in Certificate A), encrypts that certificate with the public key of the user signing Certificate A, and signs the certificate Certificate B with his private key.
(xiii) The Access Verification Server sends the encrypted and signed Certificate B to the Data Control Server, or optionally, a simple confirmation.
(xiv) The Data Control Server sends to the Local Agent a confirmation that the operation has been processed, and optionally, the Certificate B obtained from the Access Verification Server.
(xv) The Local Agent:
a) checks that the Data Control Server reports that the operation has been performed correctly, and optionally
b) Verifies that the signature of Certificate B corresponds to the Access Verification Server, decrypts the certificate with its private key, and checks that Certificate B indicates that the Access Verification Server approves the operation and confirms it.
The above steps may be carried out, though not strictly in the said order, provided that the following order is satisfied:
i precedes ii
ii precedes iii
iii precedes iv
i precedes v
v precedes vi
vi precedes vii
vii precedes viii
viii precedes ix
viii precedes x
x precedes xi
x precedes xii
xi and xii precede xiii
xiii precedes xiv
xiv precedes xv.
When the same or another Local Agent wants to access the data:
(i) Generates a certificate (Certificate C) with access request data, encrypts the certificate with the public key of the Access Verification Server, and signs it with its private key.
(ii) Sends to the Data Control Server the access request data contained in the certificate C, as well as the said certificate encrypted and signed.
(iii) The Data Control Server verifies that the operation complies with the access protocols and, if so, sends the C Certificate, as received from the Local Agent, to the Access Verification Server.
(iv) The Access Verification Server decrypts the C Certificate with its private key, checks the signature, and checks that the signer has the necessary permissions to perform the operation specified in that certificate.
(v) If the certificate data is correct and the user has the necessary permissions, he obtains the necessary key shares to decrypt the data, includes such shares in a new certificate (Certificate D), encrypts it with the Local Agent public key, and signs it with his private key.
(vi) The Access Verification Server sends to the Data Control Server the Certificate D.
(vii) The Data Control Server returns to the Local Agent the shares it has saved to access the 345 requested data, as well as the Certificate D.
(viii) The Local Agent decrypts the D certificate with its private key and checks the signature of the Access Verification Server.
(ix) If both the Data Control Server and the Access Verification Server have given approval to the operation and have provided the necessary shares to recompose the key and decrypt the data, the Local Agent downloads the requested data from the address indicated by the Data Control Server.
(x) The Local Agent recomposes the key with which the data was encrypted from the shares sent by the Data Control Server and the Access Verification Server(s).
(xi) The Local Agent decrypts the data with the obtained key.
The above steps may be carried out, though not strictly in the said order, provided that the 355 following order is satisfied:
i precedes ii
ii precedes iii
iii precedes iv
iv precedes v
v precedes vi
vi precedes vii
vii precedes viii
viii precedes ix
viii precedes x
ix and x precede xi
